(19) United States
(12) Patent Application Publication
(10) Pub. No.: US 2007/0154786 A1
(43) Pub. Date: Jul. 5, 2007

(54) End electrode for a bipolar battery and a method for producing an end electrode

(76) Inventors: Britta Haraldsen, Horten (NO); Goran Dahlstrom, Borlange (SE); Ola Riseby, Avesta (SE)

Correspondence Address: JACOBSON HOLMAN PLLC, 400 SEVENTH STREET N.W., SUITE 600, WASHINGTON, DC, 20004, US

(21) Appl. No.: 11/579,800

(22) PCT Filed: May 3, 2005
(86) PCT No.: PCT/SE05/00644

§ 371 Date: Feb. 7, 2007

(30) Foreign Application Priority Data
May 7, 2004 (SE) 04011888-8

(51) Int. Cl. H01M 4/00

(52) U.S. Cl. 429/66

(57) ABSTRACT

An end electrode for a bipolar battery, and including a disk including lead or a corresponding metal or an alloy thereof and a current collector of metal being applied to the disk is distinguished by the current collector being firmly fastened to the metal or the alloy in the wall over a metal or an alloy having a lower melting point than the melting point of the metal or the alloy in the wall. The invention also concerns a battery and a method for producing an end electrode.

### FIELD OF THE INVENTION

The invention concerns an end electrode for a bipolar battery, a bipolar battery including at least one such an end electrode and a method for producing such an end electrode.

### BACKGROUND OF THE INVENTION

Batteries for storing energy are often produced as monopolar units which means that the positive and the negative electrodes each are parallel-coupled and connected to a current collector (pole post), which makes it possible to connect the battery to an outside element such as an electric motor, lamps for lighting or the like. At least two such current collectors, one positive and the other one negative, are provided for each cell of a battery. In certain cases only the current collectors of the outer cells are visible whereas the current collectors of intermediate cells are hidden. The current collectors are typically position in the lid of the battery in such a way that leakage of the electrolyte from the battery is prevented. Likewise, the current collectors are dimensioned for the magnitude of the current to be taken out from the battery as well as the mechanical handling that the battery can be subjected to.

In certain battery constructions one of the group of electrodes has been connected to one current collector which is positioned at the bottom of the cell container. This current collector connects the electrode in the cell in question to the electrodes of opposite polarity of the adjacent cell with a connection that is arranged electrolyte-tight in the separating wall. This method is used when great current are to be discharged from cells with high electrodes. Thereby a better and more even current distribution is obtained over the electrodes than would be the case if both current collectors were positioned upwards in the cell.

The here mentioned current collectors may vary in size, that is sectional area and length as well as in material. Long current collectors may be detrimental, since they increase the voltage drop at discharge, which results in a shorter discharge time. However, the contents of acid in the cell will be increased. If the battery is intended for low discharge currents, this arrangement does not make too much influence. However, long current collectors may be detrimental when positioning the battery at a limited space.

The material in the current collector must be such that it can be connected to the electrodes by soldering, welding in a manner which resists the electrolyte of the battery or, which exists in alkaloid batteries, through screwing. The material in the current collector further has to be able to resist the effect of the electrolyte in itself, since this will come into contact with the current collector. Further, such materials that together with other metals (for example the grids of the electrodes) form electrochemical local elements so that corrosion will occur can not be included in the current collector. Current collectors can be enforced, both with respect to conductivity as well as mechanicals strengths, with other metals. It is thus for example common in current collectors for lead batteries to have inlays of copper. This makes it possible having the outer connection with a screw fastener which is drawn with full force. The inlay can also be provided with a screw thread for the connection of firm fastenings.

Bipolar electrodes are in contrast to above mentioned monopolar electrodes produced from a positive electrode comprising one half of the bipolar electrode and a negative electrode comprising the second half. These parts are united with a, most frequently, thin, electrically conducting wall. In order to obtain a bipolar battery, plural such bipolar electrodes are laid together to a stack having separators between each electrode. The electrodes are enclosed in a container in such a way that no electrolyte connection will exists between the cells formed this way.

The one end of this stack is connected to a monopolar positive electrode and the other end to a monopolar negative electrode. Each one of these end electrodes are provided with at least one current collector for connection of outside elements.

### AIM AND MOST IMPORTANT FEATURES OF THE INVENTION

The aim of the present invention is to provide an improved end electrode for a bipolar battery. A second aim is to provide a bipolar battery including at least one such end electrode and a third aim is to provide a method of producing such an end electrode.

These aims are obtained through the features of the respective independent claims.

The invention concerns bipolar batteries wherein the end electrode includes a wall of a form-stable disk of a non-electrically conductive porous material, the pores of which being filled with lead or a corresponding metal or an alloy thereof.

By having the current collector firmly fixed to the metal or the alloy in the disk/the end electrode over a metal or an alloy having a lower melting point than the melting point of the metal or the alloy in the end electrode, several advantages are obtained besides the ones purely relating to manufacture. It is thus possible to provide a battery construction that allows discharge and also charge with high currents. It is further possible to use the electrochemical material in the best manner since the current over the electrodes will be evenly distributed to a high degree. Further, it is possible to achieve that the transition from electrode to current collector as well as the current collector itself has a low electrical resistance. Through the invention is provided a rational and low resistance solution, which is lenient to the porous disk, for arranging current collectors at this type of construction.

Through the invention, the current collector can be firmly fastened to the metal or the alloy in the wall over said metal or alloy having a lower melting point at such a temperature and in such a way that the lead in the wall does not melt.

In the case where the end electrode is provided with a preferably extruded plastic frame, the temperature at the fastening of the current collector may be held at such a low level that the plastic material in the frame will not be affected negatively.

It is preferred that the metal or the alloy having a lower melting point is a low temperature melting lead alloy. In particular it is preferred that the metal of the alloy with a lower melting point is an alloy from the group: Wood's metal, Lipowit's metal, Newton's metal, Dárcet's metal, Lichtenberg's metal.

By the current collector being fastening through soldering with the metal or the alloy with a lower melting point as solder the end electrode is possible to manufacture simply and economically.

The wall preferably includes a layer of lead or a corresponding metal or an alloy thereof, which is positioned thereon, said layer in turn being firmly united to the metal or the alloy in the wall, whereby the current collector is firmly united with this layer over the metal or the alloy with the lower melting point. Hereby enforcement is achieved of the typical thin wall. Besides, the current distribution between the wall and the current collector is enhanced.

Further advantages are obtained through the features of the other claims which will come clear from the following description.

### BRIEF DESCRIPTION OF DRAWINGS

The invention will now be described in greater detail at the background of embodiments and with the aid of the annexed drawings, wherein:

FIG. 1 diagrammatically shows an axial section through a bipolar battery according the invention,

FIG. 2 shows an arrangement for current output from a bipolar battery,

FIG. 3 shows an alternative arrangement for current output from a bipolar battery,

FIG. 4 shows, in a perspective view, a bipolar battery with arrangements for current output according to FIG. 3, and

FIG. 5 shows a flowchart over a method according the invention.

### DESCRIPTION OF EMBODIMENTS

One way of connecting a bipolar battery to an outside element would be to consider constructing the end electrodes with a flag in the same way as for monopolar electrodes. This is however, not preferred since it would lead to complications with respect of tightness. Further, such a current output would result in an uneven current distribution, at least at the end electrodes.

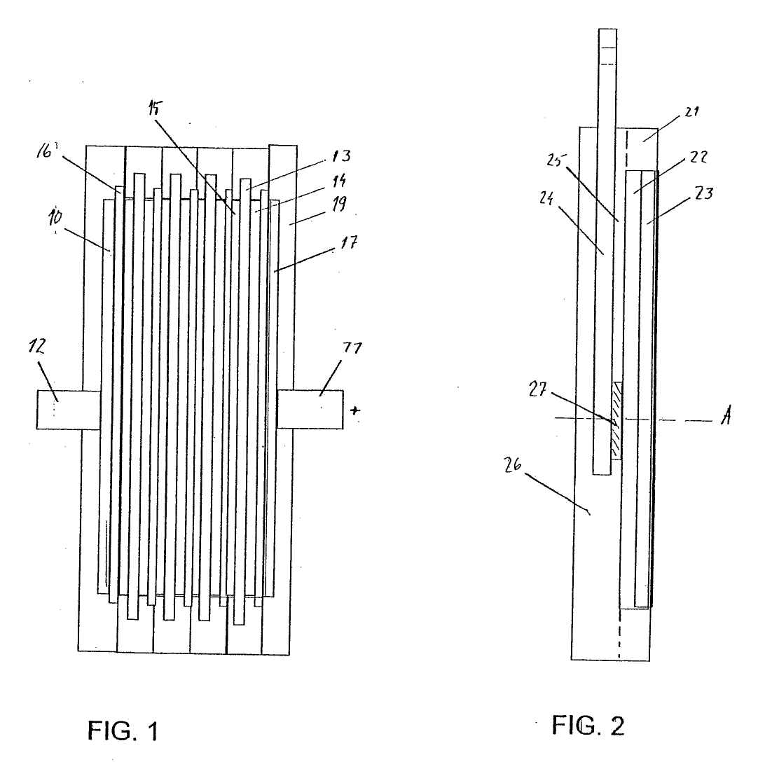

The bipolar battery in FIG. 1 includes a stack of bipolar electrodes 13, 14, 15. On each end of the stack is positioned an end electrode 10 and 17 respectively, which in itself is monopolar, having active material only on the inside, but with a backside of the same kind as the intermediate wall which is included in the bipolar electrodes of said battery.

The end electrodes are connected directly on their backsides, which thus for the positive end electrode corresponds to the negative side of the bipolar electrode and for the negative end electrode corresponds to the positive side, each with a current collector in the form of a pole rod. The construction of the current collector is in the Figure a round pole rod applied horizontally in the length direction of the battery 11, 12 through soldering, with a solder having a lower melting point than that of the metal/alloy in the wall 10 and 17 respectively. In an electrolyte tight battery stack, no electrolyte will be present at the backside of the end electrodes, wherefore the soldering in this position will be unaffected by electrolyte. A solder can thus be chosen without taking into account that it shall be able to resist the electrolyte.

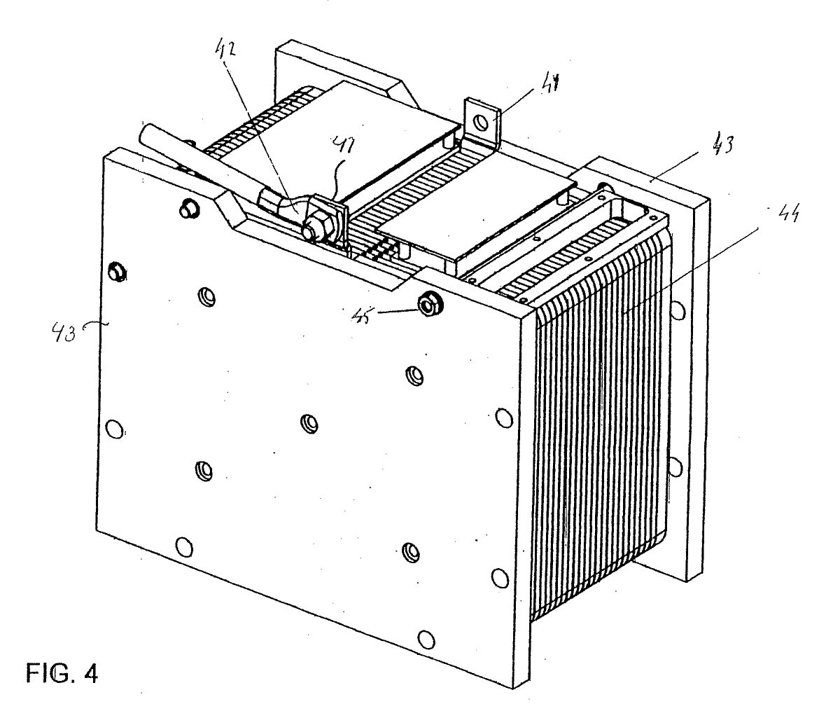

FIG. 2 shows an end electrode for a bipolar battery with a wall 22, carrying active material 23. Centrally on the backside of the wall 22 is fastened a current collector having a connecting portion in the form of a preferably round rod 27, and a rail-shaped portion 24, which extends essentially at a right angle to the axis A of the end electrode and out from the battery stack. In order to increase the conductivity of the current collector, the rail-shaped portion is preferably manufactured from copper.

In some applications or at assembly of the battery, the mechanical stress on the current collectors can be so great that there is a risk of deformation. It is therefore important to construct stable fastenings for the current collectors.

An example of a stable construction is obtained if the space behind the rail 24 is filled with a non-electrically conducting forming material, for example a two component polymer such as for example epoxy resin. Preferably this material also fills the space 25 between the rail 24 and the wall 22 and the rest of the spaces 26 behind the wall.

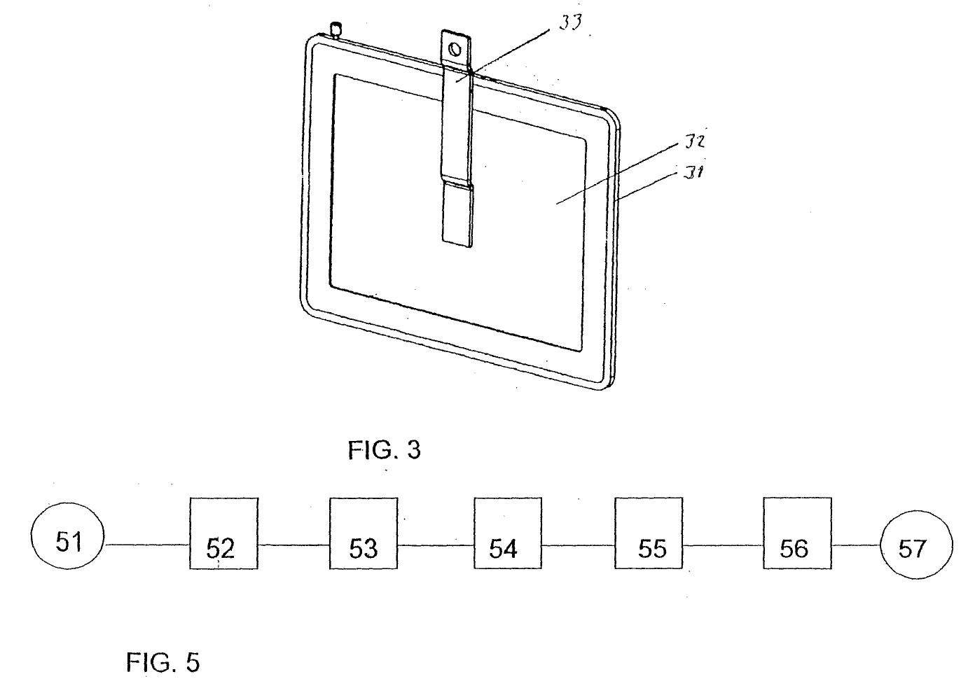

The bipolar end electrode shown in FIG. 3, onto which the connection is to be made, has a wall 32 that consists of the thinnest possible lead layer or a porous ceramic disk, the pores of which are filled with lead or a lead alloy. This wall should for manufacturing reasons be the same as the one that is used as intermediate wall in the bipolar electrodes of the battery. Further, the end electrode is provided with a surrounding plastic frame 31 and on one side with a positive and negative active material respectively (not shown in FIG. 3).

This construction results in that the end electrodes at the application of the current collector can not be subjected to temperatures higher than the melting point of the lead or the metal or alloy in the wall. Through this limitation, also the material in the frame could be chosen such that it withstands the corresponding temperature without melting or deforming.

Current collectors at end electrodes according to the invention can be connected in different directions and, besides, give special construction that is adapted to the field of use. This is achieved in the preferred construction in FIG. 3. The connection at the centre of the wall and the current collector is arranged through a copper rail that is adapted to the height of the battery. It can be surface covered with lead but this is not necessary since the current collector will be completely protected from the electrolyte (sulphuric acid). The application of it through solder having a lower melting point, according to the above, can be arranged in either case.

FIG. 4 shows a bipolar battery with a tight battery stack 44 clamped between two pressure plates 43 by screw tightening element 45 From each electrode extends a current collector 41 and a cable terminal 42 is connected to one of these.

In order to have the connection resulting in the smallest possible transition resistance it may be necessary, when connecting to i.a. intermediate walls according to U.S. Pat. No. 5,510,211, to reinforce the wall with somewhat more lead, which can be achieved through electrolytic deposition. Thereafter the current collector is soldered with a solder having a lower melting point than lead.

Examples of alloys having low melting point which can be used when producing end electrodes according to the present invention are shown in the table below:

### EXAMPLES OF LEAD ALLOYS WITH LOW MELTING POINTS THAT CAN BE USED

| | Melting Point | Pb | Sn | Bi | In | Cd |
|---|---|---|---|---|---|---|
| | ° C. | % | % | % | % | % |
| Eutecticum | 46.5 | 22.11 | 10.65 | 40.63 | 18.1 | 8.2 |
| Eutecticum | 47 | 22.6 | 8.3 | 44.7 | 19.1 | 5.3 |
| Eutecticum | 58.2 | 17.6 | 11.6 | 49.5 | 21.3 | |
| Wood's metal | 70 | 25 | 12.5 | 50 | | 12.5 |
| Lipowit's | 70 | 26.7 | 13.3 | 50 | | 10 |
| metal | | | | | | |
| Eutecticum | 91.5 | 40.2 | | 51.6 | | 8.2 |
| Eutecticum | 95 | 32 | 15.5 | 52.5 | | |
| Newton's | 97 | 31.2 | 18.8 | 50 | | |
| metal | | | | | | |
| Darcet's | 98 | 25 | 25 | 50 | | |
| metal | | | | | | |
| Lichtenberg's | 100 | 30 | 20 | 50 | | |
| Metal | | | | | | |

Beside these specified alloys it is within the scope of the invention in general to use metals or alloys having lower melting point than the melting point of the metal or the alloy in the wall. As an example this allows use of one single metal or an alloy of lead having one, two or more alloying materials from the table when the resulting metal or alloy is a metal or an alloy having a low melting point that is intended according the invention.

A method for producing an electrode of a bipolar battery is shown diagrammatically in the flowchart of FIG. 5.

The start of the sequence is indicated with 51.

The pores of a form-stable disk of a non-electrically conducting porous material are filled with lead or a corresponding metal at position 52.

At position 53 the disk is provided with a frame of plastic material through extrusion.

A part of one side of the disk is covered with a lead layer through electrolytic depositing at position 54.

The other side is provided with a layer of active material at position 55.

A current collector of lead-coated or tin-coated copper is soldered against the centre of the side with the lead layer by using Wood's metal as solder at position 56.

Position 57 indicates the end of the sequence.

### Example 1

For the application of a current conductor to a wall of the lead-ceramic type, firstly a deposition of lead was made on a centrally positioned surface of 20 cm². The entire surface of the electrode was 226 cm². In order to complete the lead plating a PVC tube which was 5 cm in height and having an inner diameter of 5 cm and having a rubber seal was pressed against the lead ceramic. The tube was filled to ⅔ with a lead-containing plating bath and an anode of pure lead. The lead-ceramic was connected to the negative pole of a current source and the anode to the positive pole. The current was set to 0.5 A and the electrolysis was allowed to continue for 1 hour. Thereafter the wall was rinsed and dried. The plated surface was brushed with a brass brush and the wall was preheated to 80° C. A layer of Wood's metal was applied whereupon a current conductor also preheated to 80° C. was pressed against a layer of Wood's metal, whereby, after allowing cooling, a mechanically strong connection was achieved.

### Example 2

Two current conductors with dimensions 14×2×0.2 cm were applied to a lead-ceramic disk as in example 1. The resistance from one of the current conductors to the other through the lead-ceramic was measured to 0.1 mohm and the resistance between one of the sides and the other side through the layer of Wood's metal to 0.09 mohm. In the same way two current leaders were applied to a lead layer which was 2 mm thick and the resistance was measured to 0.1 and 0.09 mohm, respectively. Consequently, an equally good contact was achieved between Wood's metal and a lead/ceramic, as between Wood's metal and a lead layer.

The invention has been described with the application bipolar lead batteries and specially such with dimensional stable intermediate walls that are described in U.S. Pat. No. 5,510,211. The invention can, however, be modified within the scope of the following claims. As a modification, more than one current collectors are applied at different places on the end electrode. This is particular applicable to end electrodes having greater dimensions.

1. A end electrode for a bipolar battery, and including a disk including lead or a corresponding metal or an alloy thereof with active material applied on one side thereof and, at the other side, a current collector of metal being applied to the disk, wherein the disk includes a wall being of a form stable disk of non-electrically conductive porous material, the pores of which being filled with lead or a corresponding metal or an alloyed thereof, characterized in that the current collector is firmly fastened to the metal or the alloy in the wall over a metal or an alloy having a lower melting point than the melting point of the metal or the alloy in the wall.

2. The end electrode according to claim 1, characterized in that the metal or the alloy with lower melting point is a low temperature melting lead alloy.

3. The end electrode according to claim 2, characterized in that the metal or the alloy with lower melting point is an alloy of lead with one or more alloying materials from the group: tin, bismuth, indium, cadmium.

4. The end electrode according to claim 3, characterized in that the metal of the alloy with lower melting point is an alloy from the group: Wood's metal, Lipowit's metal, Newton's metal, Dárcet's metal, Lichtenberg's metal.

5. The end electrode according to claim 1, characterized in that the current collector is fastened through soldering with the metal or the alloy with lower melting point as solder.

6. The end electrode according to claim 1, characterized in that the wall is provided with an applied layer of lead or a corresponding metal or an alloy thereof and that the current collector is firmly fastened over the metal or the alloy with lower melting point to that layer.

7. The end electrode according to claim 1, characterized in that the current collector is manufactured from tined or leaded copper or lead or a lead alloy.

8. The end electrode according to claim 1, characterized in that the current collector has a circular section.

9. The end electrode according to claim 1, characterized in that the wall has a circular or polygonal section.

10. The end electrode according to claim 1, characterized in that the current collector is fastened centrally to the disk.

11. The end electrode according to claim 1, characterized in that more than one current collectors are fastened to the disk.

12. The bipolar battery including a plurality of intermediate walls, active materials, two end electrodes and electrolyte, characterized in that it includes at least one end electrode according to claim 1.

13. The battery according to claim 12, characterized in that it includes a tight container with sealing means between the container and a current collector extending from each end electrode and protruding from the container.

14. The battery according to claim 12, characterized in that the current collectors are mounted essentially in parallel with the axis of a stack formed by said plural cells.

15. The battery according to claim 12, characterized in that the current collectors are mounted essentially at the right angle to an axis of a stack formed from said plural cells.

16. A method for producing an end electrode for a bipolar battery including a disk including lead or a corresponding metal or an alloy thereof and a current collector of metal being applied to the disk, wherein said disk includes a wall of a form-stable disk of non-electrically conducting porous material, the pores of which being filled with lead or a corresponding metal or an alloy thereof, characterized in, that the current collector is firmly fastened to the metal or the alloy in the wall over a metal or an alloy with lower melting point than the melting point of the metal or the alloy in the wall.

17. The method according to claim 16, characterized in, that the metal or the alloy with lower melting point is a low temperature melting lead alloy.

18. The method according to claim 17, characterized in, that the metal or the alloy with lower melting point is an alloy of lead with one or more alloying materials from the group: tin, bismuth, indium, cadmium.

19. The method according to claim 16, characterized in, that the metal or the alloy with lower melting point is an alloy from the group: Wood's metal, Lipowit's metal, Newton's metal, Dárcet's metal, Lichtenberg's metal.

20. The method according to claim 16, characterized in, that the current collector is fastened to the wall through soldering with the metal or the alloy with lower melting point as solder.

21. The method according to claim 16, characterized in, that the wall is covered with a layer of lead or a corresponding metal or an alloy thereof and that the current collector is firmly fastened to this layer over the metal or the alloy with lower melting point.
